(19) United States
(12) Patent Application Publication
(10) Pub. No.: US 2013/0036534 A1
(43) Pub. Date: Feb. 14, 2013

(54) BURNOVER SHELTER

(71) Applicant: Cameron Williams, Kangaroo Flat (AU)

(72) Inventor: Cameron Williams, Kangaroo Flat (AU)

(21) Appl. No.: 13/492,451

(22) Filed: Jun. 8, 2012

(30) Foreign Application Priority Data
Aug. 9, 2011 (AU) 2011903185
Dec. 2, 2011 (AU) 2011905027

(51) Int. Cl. A62B 17/00

(52) U.S. Cl. 2/455

(57) ABSTRACT

This invention relates to a burn-over shelter comprising a sleeve closed at one end and a first opening at an opposing end to enable the sleeve to be fitted over the head of a wearer to cover at least the torso and head of the wearer with the head at the closed end of the sleeve. The sleeve includes a second opening at a position that enables the wearer to pass at least one arm through the second opening from inside the shelter.

### FIELD OF THE INVENTION

The present invention relates to fire protection equipment.

In particular the present invention relates to personal fire protection equipment. The present invention has particular, although not exclusive application, to fire resistant barriers for fighting wildland fires and in particular barriers for fire-fighter that are overrun by an advancing fire front, i.e. a burn-over.

### BACKGROUND

Fire-fighters fighting wildland fires face many hazards when performing their duties. One of the greatest dangers they face is being overrun by an advancing fire front, also known as a burn-over.

While fire fighters are trained to avoid burn-overs, they also carry a fire shelter to provide protection. A standard fire shelter is a tent like structure that provides protection from radiant heat and also toxic gases. Fire fighters typically deploy their fire shelter in an area cleared of vegetation and are trained to deploy the shelter within 30 seconds.

Vehicles are widely used during fire fighting operations especially in the urban/wildland interface. Vehicle based fire fighters also face the risk of burn-overs. These fire fighters face the dilemma of either staying inside the vehicle during the burn-over or leaving and deploying there fire shelter. Often the burn-over can occur so rapidly the fire fighter is forced to stay inside the vehicle

During a burn-over a fire fighter sheltering inside a vehicle can be exposed to high levels of radiant heat, high ambient temperatures and toxic gases. In some circumstances these conditions can force a fire fighter to exit the vehicle, even while the burn-over is still occurring. Until now fire fighters sheltering inside a vehicle had very limited means of protecting themselves.

Its an object of the invention to provide a fire shelter with improved protection qualities for vehicle based fire fighters trapped in a burn-over. The fire shelter may also provide improved protection qualities for urban/wildland interface fire fighters.

### SUMMARY OF THE DISCLOSURE

Accordingly, there is provided a burn-over shelter comprising a sleeve closed at one end and a first opening at an opposing end to enable the sleeve to be fitted over the head of a wearer to cover at least the torso and head of the wearer with the head at the closed end of the sleeve, the sleeve including a second opening at a position that enables the wearer to pass at least one arm through the second opening from inside the shelter and wherein the burn-over shelter is formed of a reflective material for reflecting a majority of incident radiant heat.

A fire-fighter enters the burn-over shelter through the first opening so that the shelter substantially envelops the fire-fighter. The second opening allows a fire-fighter to view conditions outside the burn-over shelter and to perform tasks external to the shelter including opening doors and operating radios while being substantially covered by the burn-over shelter. Being able to view conditions outside the burn-over shelter is important for situational awareness and, therefore, for making decisions about what action to take.

The shape of the burn-over shelter as a sleeve provides a significant advantages because the shelter can be closed simply by closing the first and second openings.

For example, in a fire truck, this is achieved by fitting the burn-over shelter, sitting in the cabin in the normal manner and the wearer using their feet to hold the first opening closed and their hands to close the second opening closed, respectively.

When the first and second openings are closed, air is trapped inside the burn-over shelter and provides several minutes of air at a breathable temperature. Additionally, the primary access opening is located at a position low inside the cabin. This is where the coolest air in the cabin is located. Accordingly, the first opening can be used to access relatively cool air (generally around 50° C.) compared to air around head level in the cabin which may be around 200° C.).

An advantage of the shape of the burn-over shelter is also that it is relatively air-tight when the preliminary and secondary access openings are closed. This reduces the extent to which smoke and toxic fumes can enter the burn-over shelter. This also allows it to be used in conjunction with an air cylinder or air-line to provide additional breathable air, from a compressed air source, to the fire-fighter within the shelter. An elevated air pressure can be maintained with the additional breathable air so that any gas leaks of the burn-over shelter are of gas leaking out of the burn-over shelter. This generally prevents ingress of smoke and toxic gases into the burn-over shelter.

Additionally, the pressurisation of the shelter by the compressed air allows the fire-fighter to peep through the secondary access opening without compromising the breathable air within the shelter.

Alternatively, the shelter may be used with a constant flow breathing apparatus to provide additional breathable air to the fire-fighter, so the fire-fighter can remain in the burn-over shelter for longer.

The term “majority” is taken to mean more than 50%.

The burn-over shelter may be constructed to be 60 to 140 cm wide and 120 to 200 cm in length. Preferably, the width is 80 to 120 cm and the length is 140 to 180 cm.

The second opening may be 20 to 70 cm in length. Preferably, the second opening is 40 to 60 cm in length.

The second opening may include a closure for retaining the opening in a closed position. The closure may comprises a hook and loop fastener, one or more press-fit buttons or a zipper.

The first opening may configured to be closed by sitting on the reflective material surrounding the first opening.

The second opening preferably is at eye-level of a wearer when the burn-over shelter is worn by a wearer.

The burn-over shelter may be formed of a single layer of the reflective material and, optionally, the reflective material may be aluminised material.

Forming the burn-over shelter from a single layer of reflective material enables the burn-over shelter to be lightweight (i.e. less than 1.5 kg) and compacted to a small volume for storage and for carrying by an individual. This allows fire-fighters to carry the burn-over shelter with them when they leave a vehicle to fight fire or when forced to leave the cabin of a fire truck to avoid toxic fumes. The compact and lightweight nature of the burn-over shelter in this form avoids the need to carry heavy and bulky fire blankets that, because of their size and weight, interfere with the ability of fire-fighters to operate effectively.

Additionally, the burn-over shelter in this form may be used by homeowners that choose to remain at their house during a wildland fire. The burn-over shelter may be deployed in the event that the house catches fire and the homeowner is forced to flee the house.

The burn-over shelter may include a vapour impermeable layer and/or a heat-insulating layer.

The burn-over shelter may further comprise an inner layer formed of the heat-insulating layer.

It is anticipated the combination of the reflective material and the inner heat-insulating layer will restrict the temperature within the burn-over shelter to no more than about 50° C. during a burn-over event.

The material may comprise an outer layer formed of the reflective layer that covers the burn-over shelter entirely or at least partially. In one form, the reflective layer may cover a top half of the burn-over shelter when worn by a wearer.

The vapour impermeability of the material may be provided by the reflective material. Alternatively, vapour impermeability may be provided by the material further including the vapour barrier layer.

While the primary role of the reflective material is to provide protection from the intense radiant heat associated with a burn-over, the reflective material may be formed of a material that also imparts strength to the burn-over shelter to prevent the shelter from being easily damaged. Additionally, the material forming the outer layer may be generally gas impervious so as to act as a vapour barrier against smoke, toxic gases, water and steam entering the burn-over shelter through the material.

The insulating layer operates to delay conductive heat transfer from the reflective fabric to the wearer inside the burn-over shelter. The thickness of the inner insulating layer may be tailored to customise the degree of protection afforded to the fire-fighter forming the heat-insulating layer of one or more layers of heat-insulating material. Accordingly, the inner insulating layer can be modified depending on the required protection standard to be met,

The role of the vapour impermeability is to reduce ingress of smoke and toxic gases into the shelter, particularly in the event that decomposition of the reflective fabric and/or insulating layer occurs.

The vapour impermeability is important where the burn-over shelter is to be used in conjunction with sprinklers or sprays of water for controlling the temperature outside the burn-over shelter. In these circumstances, the ambient heat can turn the sprayed water into steam. If this reaches the interior of the burn-over shelter, the wearer is exposed to breathing steam which burns the throat and lungs.

The reflective fabric may be the outer layer and may be aluminized fibreglass, aluminized PEI, aluminized preox, aluminized aramid or aluminized para-aramid.

The reflective material may have a tensile strength>450 N, and a tear strength of 5×5 lbs when tested in accordance to ISO 13934-1 and ASTM D1424 (Elmendorf Tear).

The insulating layer may be formed of a material that provides the shelter at least 17.5 seconds of protection from an 84 kW/m² (2 cal/cm²) flame according to NFPA Thermal Protection Performance—TPP test. This is the standard required in NFPA 1971, Standard on Protective Ensembles for Structural Fire Fighting and Proximity Fire Fighting.

The insulating layer may comprise one or more of PBI, wool, aramid, preox, para aramid, cotton, rayon, P84 and CarbonX.

The burn-over shelter may provide at least 150 seconds of protection from 20 kW/m² radiant heat according to International Standard ISO 6942.

The vapour barrier layer may comprise polychloroprene (neoprene), polyurethane, teflon, silicone or aluminized fabric.

### BRIEF DESCRIPTION OF THE DRAWINGS

An embodiment of the invention will now be described, by way of example only, with reference to the accompanying drawings, in which:

FIG. 1 is a side view of a burn-over shelter in accordance with an embodiment of the invention.

FIG. 2 is a partial oblique view of the burn-over shelter in FIG. 1.

FIG. 3 is an oblique cross-sectional view of a material from which the burn-over shelter in FIG. 1 is formed.

FIG. 4 is a view of a standard fire blanket of rectangular periphery.

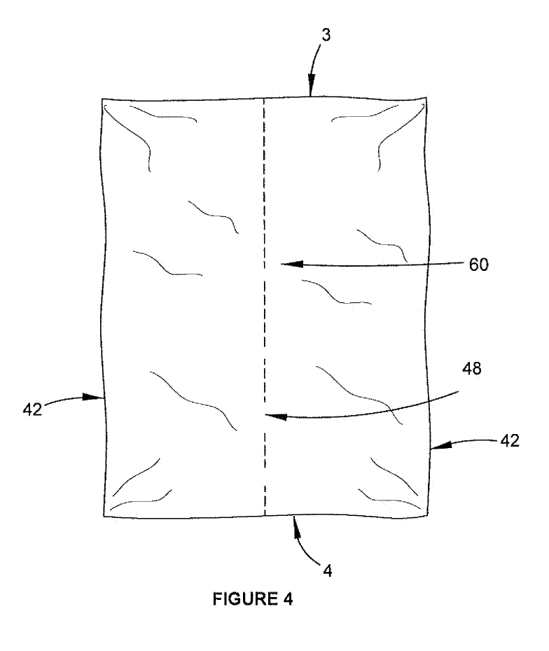

FIG. 5 is a perspective view of another embodiment of the invention.

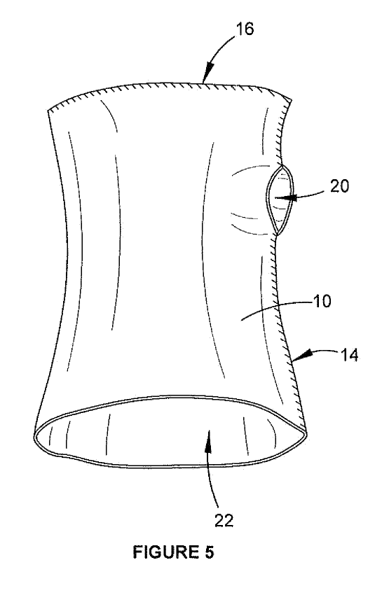

### DETAILED DESCRIPTION

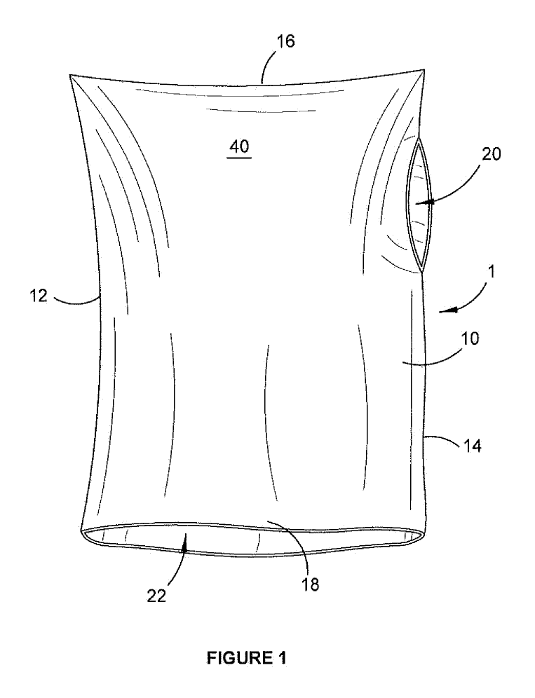

An embodiment of a burn-over shelter is illustrated in FIG. 1 and is denoted by reference numeral 1.

The burn-over shelter 1 comprises a sleeve in the form of a pocket 10 having one end closed at an upper seam 16 and the opposite end open as a first opening, in the form of an access opening 22.

In this particular embodiment, the pocket 10 is formed of two panels joined together along the top seam 16 and front and rear seams 14, 12. The width of the shelter is along seam 16 and the length of the shelter is along seam 12.

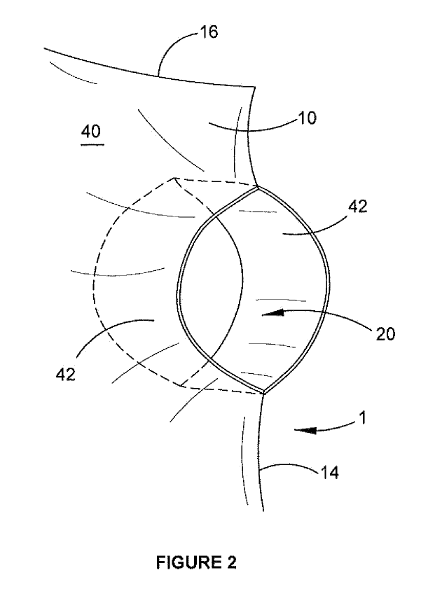

The front seam 14 is incomplete between the access opening 22 and the top seam 16 to provide a second opening in the form of an operative opening 20. Flaps 42 of additional material (FIG. 2) surround the operative opening 20 and project inwardly into the interior of the pocket 10 to enable a wearer to grasp the flaps 42 and hold the operative opening 20 in a closed position. In this manner the operative opening 20 may be closed to prevent ingress of air at that level within the cabin of a fire vehicle.

Alternatively, the flaps 42 may be retained closed by suitable fasteners (not shown), thereby freeing the hands of the wearer for other purposes. Suitable fasteners include hook and loop fasteners, press-fit buttons and zippers.

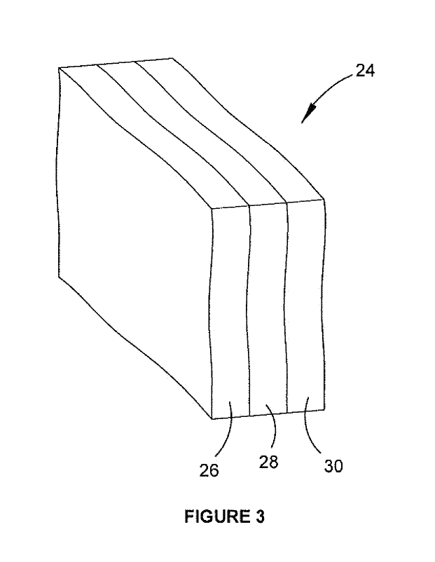

In one embodiment, the burn-over shelter 1 is formed of a reflective material in the form of an aluminised material 26. The aluminised material 26 may be complemented by additional layers in the form of a layered fabric 24 (FIG. 3) that has an inner heat-insulating layer, in the form of a non-woven nomex layer 28, sandwiched between the aluminised material 26 and a vapour barrier layer, in the form of a neoprene layer 30.

The aluminised material 26 provides protection against radiant heat while the non-woven nomex layer 28 minimises conductive and convective heat transfer to the fire-fighter. Neoprene layer 30 prevents smoke and toxic gases passing through the panels 40 into the shelter.

In the cabin of a fire vehicle, a fire-fighter employs the burn-over shelter by pulling the shelter over his/her head via the access opening 22 so the upper end 16 rests on the head of the fire-fighter. This brings the operative opening 20 generally to face-level of the fire-fighter who can then control the operative opening 20 with their hands. This allows the fire-fighter to manipulate objects or perform tasks external to the shelter by reaching through operative opening 20. Operative opening 20 can also be used as a peephole to observe the surrounding environment.

In the event that further protection from noxious fumes or intense heat is required, the fire-fighter may use their body weight to close the access opening 22 by sitting on the fabric along the perimeter 18 of the access opening 22. This traps breathable air in the shelter and maintains a lower temperature within the shelter 1 relative to the external environment during a burn-over.

The amount of breathable air within the shelter 1 can be supplemented by compressed air. A constant flow breathing apparatus or air line provides additional breathable air and may help pressurise the shelter to significantly increase the time a fire-fighter can spend in the shelter.

The supply of additional breathable air provides the shelter 1 with an elevated air pressure relative to the external air pressure. Accordingly, there will be a general flow of air out of the shelter 1, rather than a steady ingress of smoke and toxic gases.

The burn-over shelter also provides protection and mobility to the fire-fighter if the decision is taken to leave the cabin. Specifically, the access opening 22 is located at or near the feet of a wearer in a standing position. The wearer can, therefore, walk or run unimpeded whilst still wearing the burn-over shelter. The operational opening 20 becomes important for this purpose because it allows a wearer to view conditions and obstacles outside the burn-over shelter.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A burn-over shelter comprising a sleeve closed at one end and a first opening at an opposing end to enable the sleeve to be fitted over the head of a wearer to cover at least the torso and head of the wearer with the head at the closed end of the sleeve, the sleeve including a second opening at a position that enables the wearer to pass at least one arm through the second opening from inside the shelter and wherein the burn-over shelter is formed of a reflective material for reflecting a majority of incident radiant heat.

2. A burn-over shelter as defined in claim 1, wherein the burn-over shelter further comprises a vapour impermeable layer and/or a heat-insulating layer.

3. A burn-over shelter as defined in claim 2, wherein the reflective material comprises an outer layer of the burn-over shelter.

4. A burn-over shelter as defined in claim 1, wherein the second opening is at eye-level of a wearer when the burn-over shelter is worn by a wearer.

5. A burn-over shelter as defined in claim 4, wherein the second opening may include a closure for retaining the opening in a closed position.

6. A burn-over shelter as defined in claim 1, wherein the shelter is 60 to 140 cm wide and 120 to 200 cm in length and the second opening is 20 to 70 cm in length.

7. A burn-over shelter as defined in claim 6, wherein the closure is selected from the group comprising: a hook and loop fastener, one or more press-fit buttons or a zipper.

8. A burn-over shelter as defined in claim 1, wherein the first opening is configured to be closed by sitting on the reflective material surrounding the first opening.

9. A burn-over shelter as defined in claim 1, wherein the burn-over shelter may be formed of a single layer of the reflective material.

10. A burn-over shelter as defined in claim 10, wherein the burn-over shelter may provide at least 150 seconds of protection from 20 kW/m² radiant heat according to International Standard ISO 6942.

11. A burn-over shelter as defined in claim 1, wherein the burn-over shelter further comprises an inner layer formed of a heat-insulating layer.

12. A burn-over shelter as defined in claim 11, wherein The heat insulating layer may comprise one or more of PBI, wool, aramids, preox, para aramid, cotton, rayon, P84 and CarbonX.

13. A burn-over shelter as defined in claim 10, wherein the reflective material comprises an outer layer that covers the burn-over shelter at least partially.

14. A burn-over shelter as defined in claim 12, wherein the burn-over shelter has an outer layer comprising the reflective material and an inner layer comprising a vapour impervious barrier and/or a heat insulating layer and wherein the outer layer may be detachable from the inner layer.

15. A burn-over shelter as defined in claim 13, wherein the vapour impervious barrier comprises polychloroprene (neoprene), polyurethane, teflon, silicone or aluminized fabric.

16. A burn-over shelter as defined in claim 1, wherein the reflective material is vapour impervious.

17. A burn-over shelter as defined in claim 1, wherein the reflective material may be aluminized fibreglass, aluminized PBI, aluminized preox, aluminized aramid or aluminized para-aramid.
